(19) United States
(12) Patent Application Publication
(10) Pub. No.: US 2007/0283314 A1
(43) Pub. Date: Dec. 6, 2007

(54) A Method and System for Performing a Change-Over to a Component of a Computing System

(76) Inventors: Dennis Michael Browning, St. Louis, MO (US); Walter Canis, St. Louis, MO (US); Rhonda Childress, Austin, TX (US); Patrick B. Heywood, Louisville, CO (US); William John Hladik, Harrisburg, NC (US); Eli Kirzner, Haifa (IL); Dean Har'el Lorenz, Haifa (IL); Yosef Moatti, Haifa (IL); Ezra Silvera, Haifa (IL); Gal Sivan, Nesher (IL); Martin Jacob Tross, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/422,111

(22) Filed: Jun. 5, 2006

(51) Int. Cl. G06F 9/44

(52) U.S. Cl. 717/100

(57) ABSTRACT

Disclosed are methods and systems for performing a change-over to one or more components of a computing system. As part of a change-over procedure to one or more system components (i.e. software routines) of a production computing system, a clone of one or more production system components of the production computing system may be generated on the same computing platform as the production computing system component is running. According to some embodiments of the present invention, “virtualization” is one technique which may be used to generate and maintain a clone system component or virtual machine.

### FIELD OF THE INVENTION

The present invention generally relates to the field of computing systems. More specifically, the present invention relates to the application of change-over or update of computing (data processing) system.

### BACKGROUND

Computing systems often include one or more host computers (“hosts”) for processing data and running application programs, direct access storage devices (DASDs) for storing data, and a storage controller for controlling the transfer of data between the hosts and the DASD.

Client computers may communicate with a computing system through either a direct communication link or through a distributed data network such as a network utilizing Transmission Control Protocol—Internet Protocol (“TCP/IP”). A client computer may either send data to, or receive data from the computing system. The client computer may submit a request for data stored on or generated by the computing system, and in other instances the client may send the computing system data to be stored on the computing system. One example of such a computing system is a bank's computer system, which system may either: (1) provide a client computer information relating to a particular bank account, or (2) may store information from a client regarding a transaction relating to an account. Any interaction between a client computer and a computing system may be termed a transaction.

Computing systems which provide data to client computers may also be termed servers or server clusters, such as the one shown in FIG. 1. A computing system may be comprised of one or multiple servers, where each server in a multi-server computing system may play either a unique or redundant role relative to other servers in the system. For example, within a computing system, such as the one shown in FIG. 1, which is accessible to the general public through a distributed network such as the Internet (i.e. Internet Web Site), there may be three layers/types of servers: (1) WEB/HTML servers, (2) application servers and (3) database servers.

Although FIG. 1 shows separate physical hardware for each type of server, in some cases a single computing platform (e.g. single processor or multiprocessor computer) may support one or more servers and server types. For example, a single computer platform may run in parallel: (1) a web server application, (2) an application server application, and (3) a database application. If the computing platform is sufficiently powerful and the maximum rate/volume of transactions is sufficiently low, the computing platform may run multiple sets of server applications, where each set of server applications may be associated with a separate website and/or a separate computing system.

When the expected rate and/or volume of transactions for a given computing system is sufficiently high and/or when high system availability is required, hardware redundancy may be required and multiple computing platforms may be incorporated as part of a single computing system as shown in FIG. 1, and further exemplified in the system of FIG. 2. FIG. 2 shows a block diagram of an extended computing system including at least two server clusters connected to one another through a common router where each cluster comprises multiple tiers of servers. As exemplified by the right pointing arrows from the router, load balancer and servers, this extended system can be scaled upward include more clusters of servers. An extended computing system, such as the one shown in FIG. 2 may function such that all the computing platforms (e.g. servers) operate as part of a unified production computing system, or portions of the extended computing system may be part of a secondary mirrored computing system maintained as a mirrored backup system in the event the primary computing system fails.

To maintain high availability of the functionality a given computing system in production (i.e. being used by client computers) provides clients, a secondary/backup computing system is typically maintained. Many computing systems and their associated storage controllers known in the prior art may be associated with multiple/redundant hardware clusters. Each hardware cluster may comprises a processor complex, cache, non-volatile storage (NVS), such as a battery backed-up Random Access Memory (RAM), and separate power supply to provide connection paths to the attached storage.

Another application of redundant mirrored computing systems, aside from failover security and load balancing, is testing of a system change-over or system update prior to the change-over/update being applied to the production system. The term “change-over” as used in this application may include any updating or modification of system component code, either during runtime or at intervals between code execution. Since any change or update to a complex computing systems may have unanticipated and undesirable results (e.g. system crash), it has become common practice to first apply the updates within a testing environment, which testing environment includes a mirrored copy or clone of the production environment. Should the testing of the change-over/update be successful and the updated system perform stably within expected performance parameters, the same change-over or update may then be performed on the production system. An exemplary timeline showing the application of a change-over to a production component in a computer system is shown in FIG. 3A.

Several drawbacks of the presently known methodology and technology for system (i.e. system component(s)) change-over are: (1) a need for redundant hardware for testing, (2) non-negligible downtime of the production system, and (3) an excessive number of complex steps.

### SUMMARY OF THE INVENTION

There is provided in accordance with some embodiments of the present invention a method and system for performing a change-over to one or more components of a computing system. According to some embodiments of the present invention, as part of a change-over procedure to one or more system components (i.e. software routines) of a production computing system, a clone of one or more production system components of the production computing system may be generated on the same computing platform as the production computing system component is running. According to some embodiments of the present invention, “virtualization” is one technique which may be used to generate and maintain a clone system component. Since a production computing system may include: (1) one or more system components running on the same computing platform, or (2) two or more components running on separate computing/hardware platforms, it is possible to consider one or more related production system components (i.e. all components related to the same computing system) running on a common computing platform as being part of a single Virtual Machine (“VM”). Thus, when performing cloning of one or more system components running on a common platform, as part of a virtualization technique, the related system components may be part of a single VM and may be cloned in one step.

Each computing platform may also support two or more related or unrelated virtual machines running in parallel while having little to no correlation between their function and/or activities to the extent those functions or activities to do not compete with one another for platform resources. Virtualization within a computing environment and within a single computing platform is well known. Any such technique/methodology presently known or to be devised in the future may be applicable to the present invention.

After cloning one or more system components which are in production, the one or more cloned components may receive substantially identical data as the data received by their corresponding production components, such that the cloned components operate in a substantially mirrored manner to that of their corresponding production components. According to some embodiments of the present invention, the cloned components may receive and execute transaction requests but may be blocked from acknowledging transaction requests and/or transaction execution, such that the cloned components existence is transparent to clients.

According to further embodiments of the present invention, the changed-over clone may be connected to a testing environment in order to undergo a predefined set of testing routines.

According to further embodiments of the present invention, a change-over may be applied to one or more of the cloned components. The one or more cloned components may continue to run in a mirrored manner during and/or after the change-over. Once a change-over on the one or more cloned components is completed, the behavior of the one or more cloned components may be monitored to determine whether the one or more cloned components are: (1) stable, (2) performing within expected parameters, and (3) interfering with any other components or application running on the computing platform or within the computing system. A cloned system component may be considered to have passed testing if after its change-over it remains stable, performs within expected parameters and does not interfere with other components or application running on the computing platform or within the computing system.

According to some embodiments of the present invention, a cloned system component which passes testing may replace its corresponding production system component from which it was cloned. According to some embodiments of the present invention, the replaced production component may cease running (i.e. be terminated). While according to other embodiments of the present invention, the replaced component may continue to exist and operate in a background mode, be suspended, or be powered-off, such that it remains available for a roll-back procedure in the vent the new component is determined to include some defect not ascertained during testing. The original VM can be kept for roll-back in different ways: (1) it can operate in off-line mode, using minimal resources (2) it can be suspended (3) it can be powered-off—In all cases the image and VM definitions still exist.

According to further embodiments of the present invention, the change-over procedure applied to the cloned component may also be applied to the replaced component. A replaced component which has experienced a change-over may remain active as either a mirrored/backup component to the cloned component. A production computing component which is replaced may be termed a prior production computing component. A computing component which replaces a prior production computing component may be termed a current production component.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a generalized network diagram of an exemplary computer system which may be updated according to some embodiments of the present invention;

FIG. 2 shows a generalized and extended network diagram of an exemplary computer system which may be updated according to some embodiments of the present invention;

FIG. 3A is a relative timeline representing the phases of a change-over or update process according to the prior art methods;

FIG. 3B is flow diagram including the steps of a method of performing a change-over or update according to some embodiments of the present invention;

FIG. 3C is relative timeline representing the phases of a change-over or update process according to some embodiments of the present invention;

FIG. 4A is a flow diagram including the steps of a change-over/update method according to some embodiments of the present invention specific to virtualization technology;

FIG. 4B is a set of symbolic virtual machine and data structure representations indicting various virtual machine cloning and modification steps corresponding to the steps in FIG. 4A;

FIG. 4C is a set of relative timelines comparatively showing the phases of a virtual machine change-over method according to the prior art versus a virtual machine change-over method according to some embodiments of the present invention; and

FIGS. 5A & 5B show block diagrams indicating computing/hardware platform resource allocation during various phases of a change-over method according to some embodiments of the present invention.

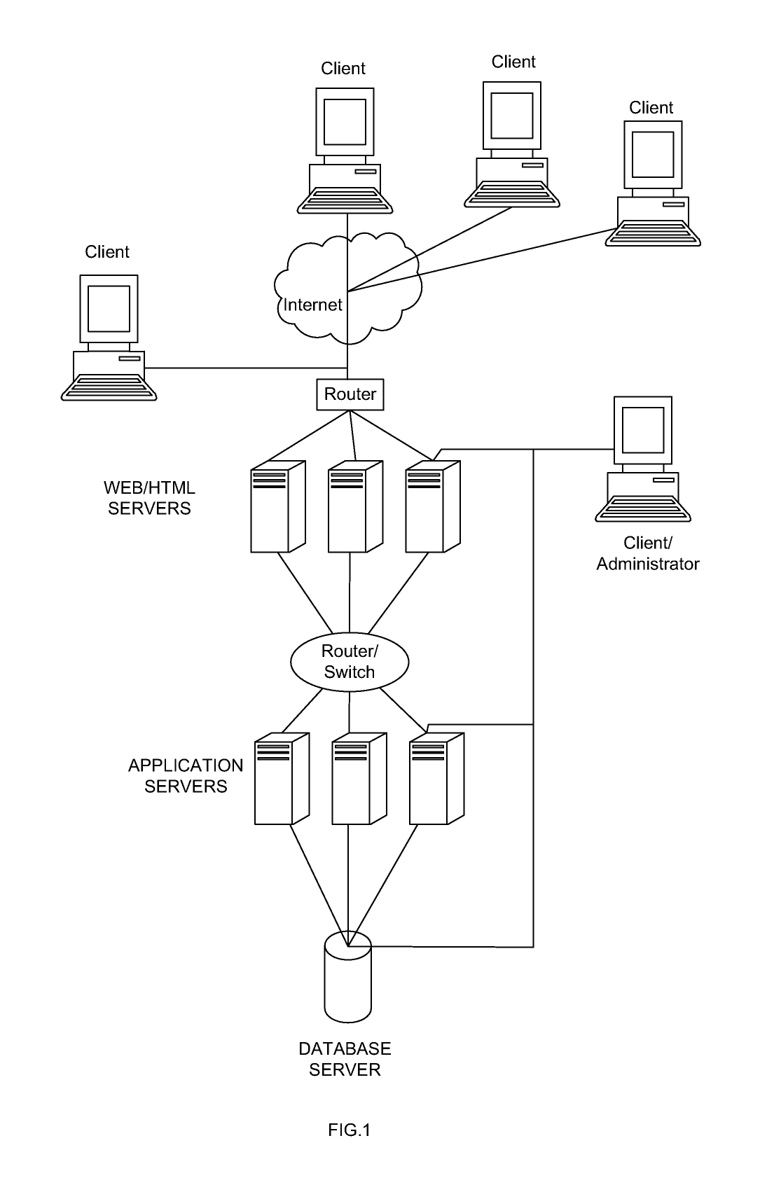

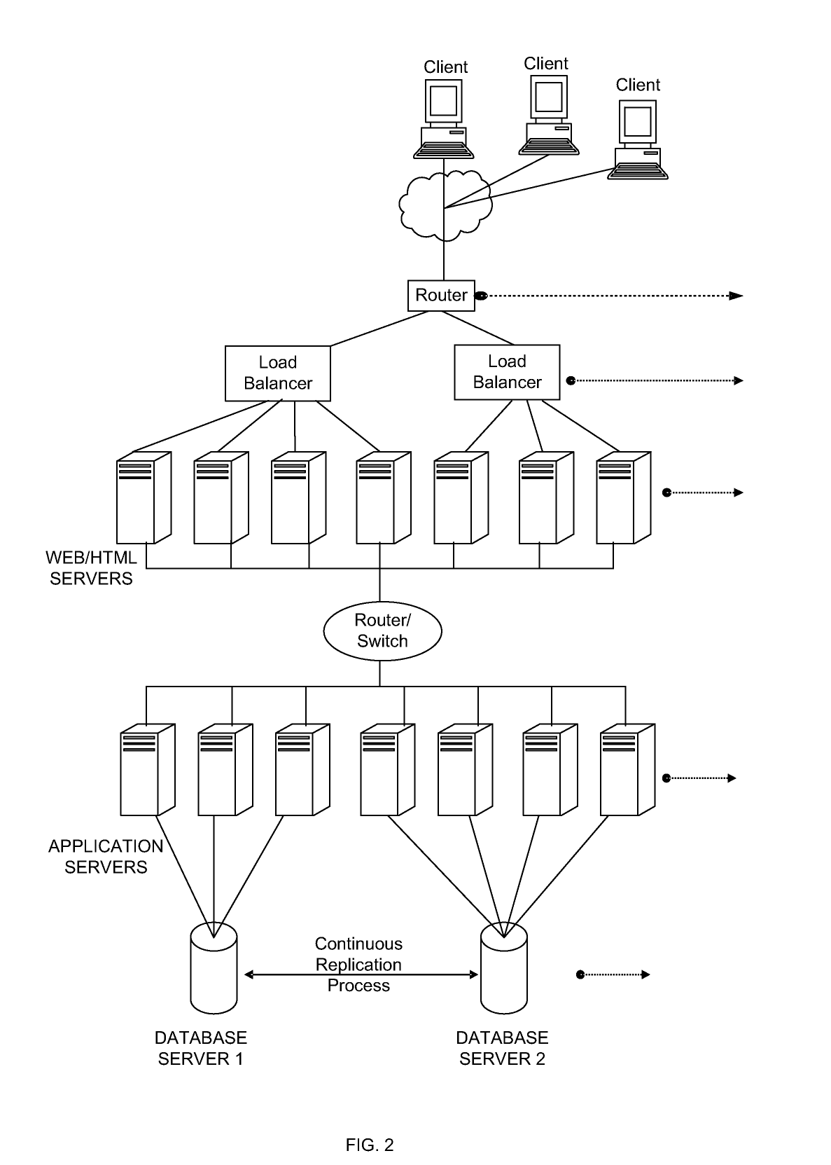

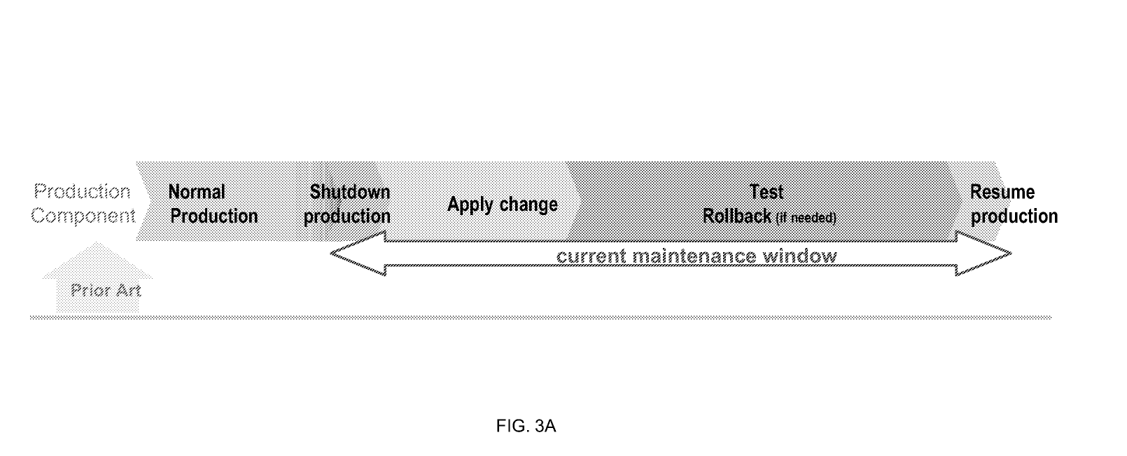

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There is provided in accordance with some embodiments of the present invention a method and system for performing a change-over to one or more components of a computing system. According to some embodiments of the present invention, as part of a change-over procedure to one or more system components (i.e. software routines) of a production computing system, a clone of one or more production system components of the production computing system may be generated on the same computing platform as the production computing system component is running. According to some embodiments of the present invention, “virtualization” is one technique which may be used to generate and maintain a clone system component. Since a production computing system may include: (1) one or more system components running on the same computing platform, or (2) two or more components running on separate computing/hardware platforms, it is possible to consider one or more related production system components (i.e. all components related to the same computing system) running on a common computing platform as being part of a single Virtual Machine (“VM”). Thus, when performing cloning of one or more system components running on a common platform, as part of a virtualization technique, the system components may be considered a single VM and may be cloned in one step.

Each computing platform may also support two or more related or unrelated virtual machines running in parallel while having little to no correlation between their function and/or activities to the extent those functions or activities to do not compete with one another for platform resources. Virtualization within a computing environment and within a single computing platform is well known. Any such technique/methodology presently known or to be devised in the future may be applicable to the present invention.

After cloning of one or more system components which are in production, the one or more cloned components may receive substantially identical data as the data received by their corresponding production components, such that the cloned components operate in a substantially mirrored manner to that of their corresponding production components. According to some embodiments of the present invention, the cloned components may receive and execute transaction requests but may be blocked from acknowledging transaction requests and/or transaction execution, such that the cloned components existence is transparent to clients.

According to further embodiments of the present invention, the changed-over clone may be connected to a testing environment in order to undergo a predefined set of testing routines.

According to further embodiments of the present invention, a change-over may be applied to one or more of the cloned components. The one or more cloned components may continue to run in a mirrored manner during and/or after the change-over. Once a change-over on the one or more cloned components is completed, the behavior of the one or more cloned components may be monitored to determine whether the one or more cloned components are: (1) stable, (2) performing within expected parameters, and (3) interfering with any other components or application running on the computing platform or within the computing system. A cloned system component may be considered to have passed testing if after its change-over it remains stable, performs within expected parameters and does not interfere with other components or application running on the computing platform or within the computing system.

According to some embodiments of the present invention, a cloned system component which passes testing may replace its corresponding production system component from which it was cloned. According to some embodiments of the present invention, the replaced production component may cease running (i.e. be terminated). While according to other embodiments of the present invention, the replaced component may continue to exist and operate in a background mode, such it remains available for a roll-back procedure in the vent the new component is determined to include some defect not ascertained during testing. According to further embodiments of the present invention, the change-over procedure applied to the cloned component may also be applied to the replaced component. A replaced component which has experienced a change-over may remain active as either a mirrored/backup component to the cloned component. A production computing component which is replaced may be termed a prior production computing component. A computing component which replaces a prior production computing component may be termed a current production component.

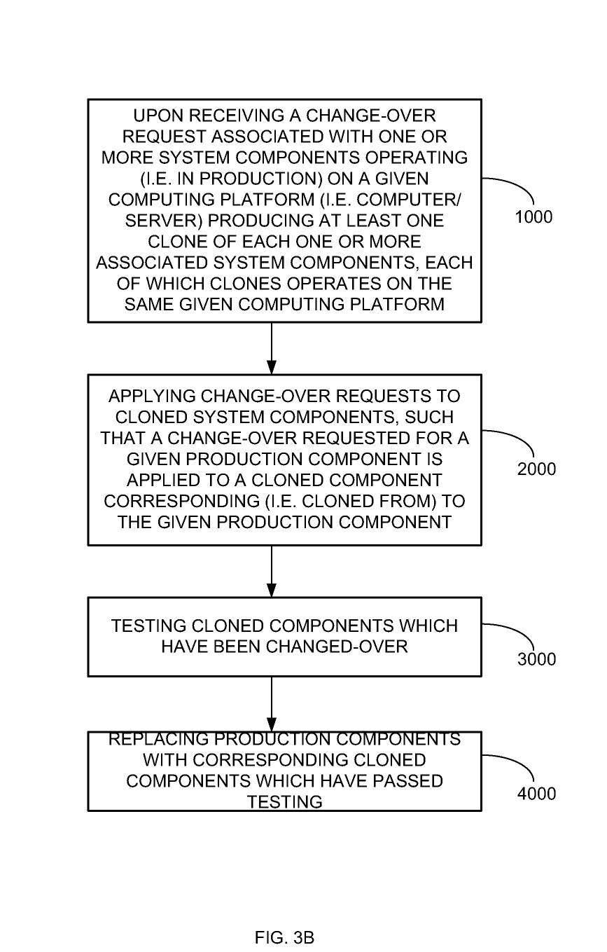

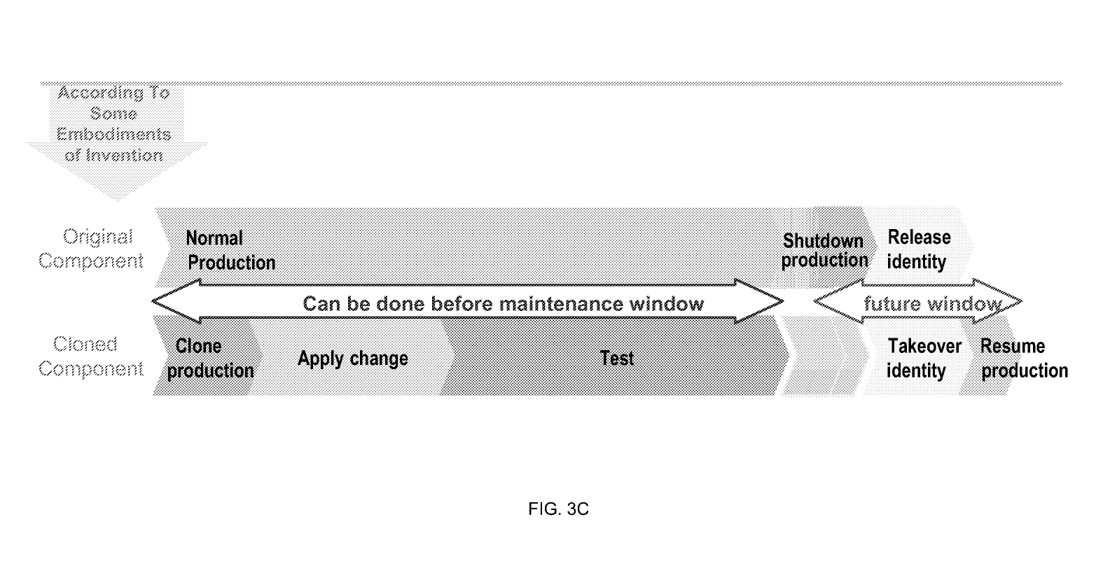

Turning now to FIG. 3B, there is shown a flow chart listing steps of a method of performing a change-over according to some embodiments of the present invention. The Steps of FIG. 3B may be understood in conjunction with FIG. 3C which shows two relative timelines, one indicating the phases of production module and the other of a corresponding clone of the production module. Thus, according to some embodiments of the present invention, upon receiving a change-over request or indication relating to a specific system component (i.e. a production component) a clone of the specific system component intended to undergo a change-over is produced (step 1000). As seen in FIG. 3C, the production component remains unchanged and continues to operate in production. The change-over intended for the production component may be applied to the clone of the production component (step 2000) and the clone may be tested (step 3000). If a cloned component passes testing, it may replace the production component from which it was cloned (step 4000). As per FIG. 3C, the step of replacing may include the sub-steps of: (a) shutting down the (prior) production component, (b) the (prior) production component releasing its system identity, (c) the cloned component which passed testing taking over the released system identity, and (d) the cloned/tested component resuming production activity instead of the prior production component.

Some methods and systems for implementing a change-over of a computing system component, according to various embodiments of the present invention, may utilize one or more virtualization techniques and/or technologies. Various virtualization environments, including P5 LPARs, VMWare, and Xen may be utilized. Various existing virtualization managers may also be used, for example VCenter may be used to manage VMWare, HMC to manage LPARs.

According to the following exemplary embodiment of the present invention utilizing virtualization, the following notations may be used: M0, M1, M2, . . . , Mn may denote server images with versions 0, 1, 2, . . . , etc. Mold and Mnew to indicate pre-change-over and post-change-over images, respectively. P may denote a production image, T may denote a testing image, and M may denote the master image. Images with the same version (e.g., P1, T1, and M1) are all based on the same image, but each is with a different identities; namely, the SoftWare stack and versions are the same, but the images were personalized differently (e.g., different IP addresses, hostnames). The master image, M is the base image from which both P and T are derived, and is typically stripped of any identity information. An Image may encapsulate the entire functionality of a server, its configuration, and its implementation—not just the particular software version. The difference between P1, M1, and T1 may be be in data that is unique to a particular instance.

For example, VM(P) may denote a virtual machine that is installed with a particular image. While VM(P0) and VM(T0) denotes two virtual machines, both installed with the same image (version 0), but one has a production identity and the other has a testing identity.

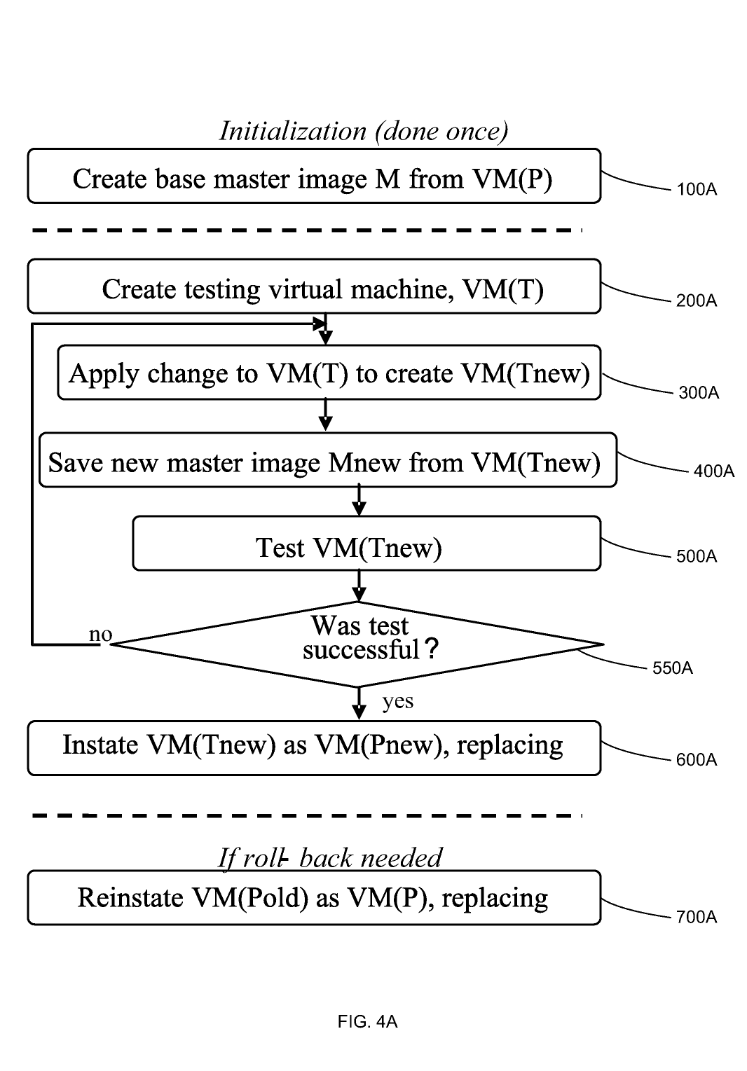

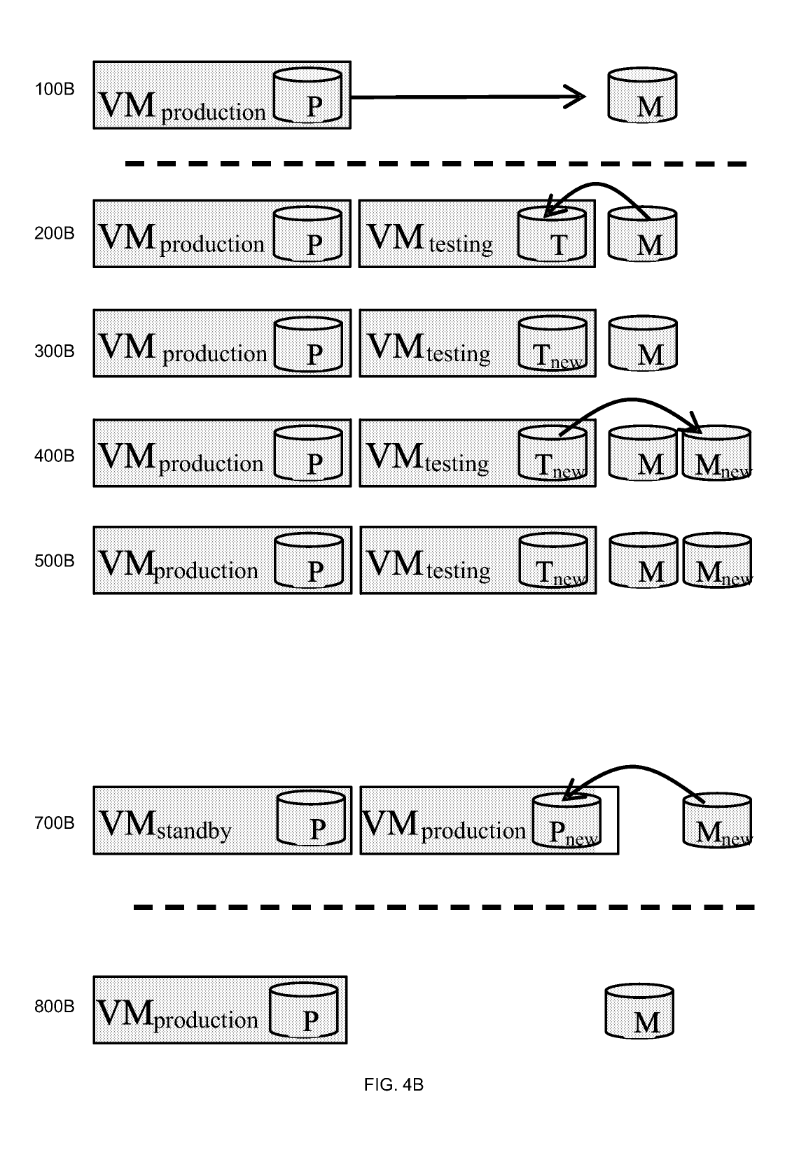

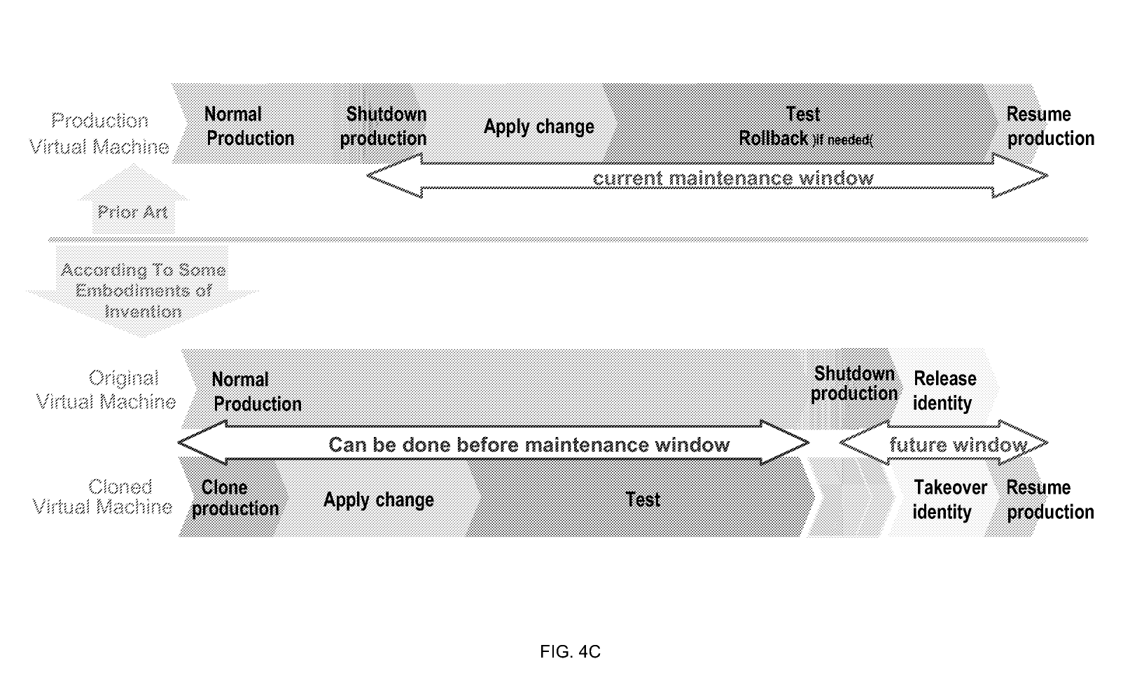

Turning now to FIG. 4A, there is shown a general flow diagram listing the steps of a method according to some embodiments of the present invention in terms associated with virtualization. More specifically, FIG. 4A describes an exemplary method by which a virtual machine that is installed with the production image P, VM(P), and assumed to be running (i.e. serving production traffic), may be updated or may receive a change-over. The steps of FIG. 4A may be understood in conjunction with corresponding columns on FIG. 4B, which show symbolic representations of the virtual machines and machine images described by each of the steps of FIG. 4A—corresponding numbers are used to associate steps in FIG. 4A with columns in FIG. 4B.

Step 100A—Create a cloned master image, M from P. This step may be required only once as initialization. It may extracts a master image M from an existing system (line 100B, FIG. 4B). If the production image P was installed from a master image to begin with (e.g., this is typical to NIM installations), the master image may already exists, and initialization may not be required. It is also possible to use P itself as the master, namely clone T directly from P with no M, provided that P can be cloned without disrupting VM(P).

Step 200A—Create a testing virtual machine, VM(T) that is a clone of VM(P). The clone may be used to apply and test changes, without disrupting VM(P). VM(T) may be installed with a testing image, T, which is a clone of M (and P) that is personalized using a testing identity to differentiate it from the original production image, P (line 200B—FIG. 4B). Furthermore, the testing virtual machine, VM(T) may be disconnected from the production environment to avoid any disruption to production traffic.

Step 300A Apply the change to VM(T) to create a new image VM(T_{new})—may use any existing patch procedure that would have been used on a physical production machine (line 300B—FIG. 4B).

Step 400A—Create a cloned master image, M_{new} from T_{new}. The clone may be used to instantiate to new production VM, once it is tested and approved.

Step 500A—Perform testing, such as any regression tests or sanity checks that can be done while the tested system, VM(T), is still disconnected from the production environment. VM(Tnew) may be used for testing without disrupting the production VM(P).

If testing fails the M_{new} can be discarded and the process retried.

Step 600A—Instate VM(T_{new}) as the new production VM(P_{new}) instead of VM(P). Accordingly, VM(P) may be disconnected from the production environment and its resources may be released. VM(P) may be suspended and kept on standby, in case rollback may be needed (Step 700A).

VM(T_{new}) may be personalized and other services (e.g., DNS) updated so that VM(T_{new}) takes the identity of VM(P); namely, all communication to/from VM(P) may now be going to VM(T_{new}) (which becomes VM(P_{new})).

VM(T_{new}) (now VM(P_{new})) may be assigned production resources; namely, the amount of resources VM(P) had before the change, during its regular operation. VM(P_{new}) may now be ready to assume the production role by being connected to the production environment and beginning to serve production traffic.

Step 700A—if rollback is needed, VM(P_{old}) resumes its role in production. VM(P_{new}) is discarded and the production resources are transferred back to VM(P_{old}).

FIG. 4C shows a set of relative timelines depicting the phases of a virtual machine change-over according to the prior art method verses the method described above in relation to FIGS. 4A & 4B.

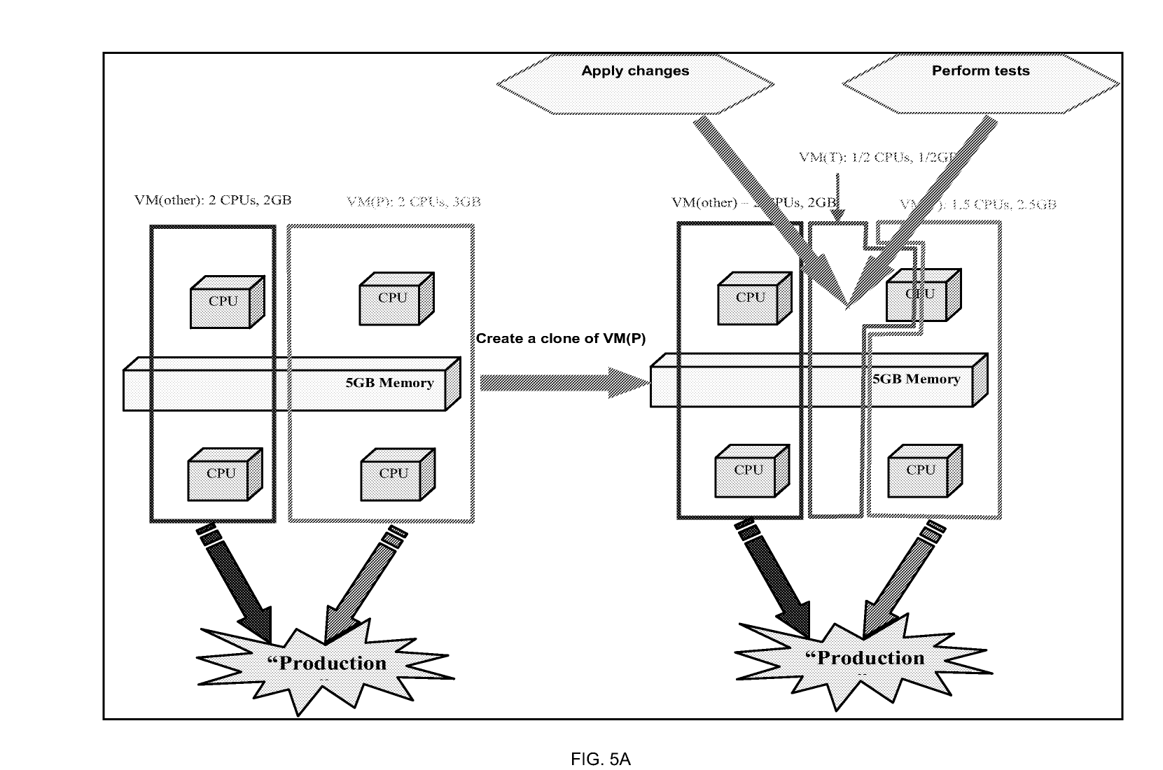

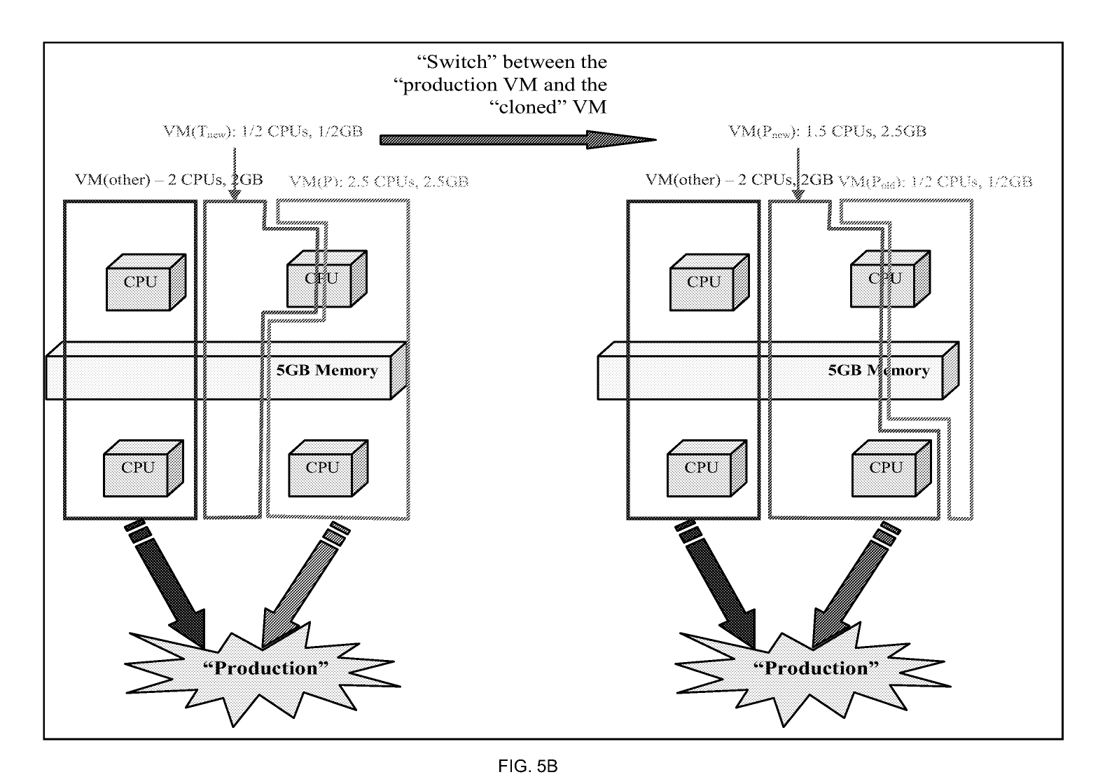

An example of computing platform (i.e. computer) resource allocation according to some embodiments of the present invention may be seen in FIGS. 5A & 5B. More specifically, left hand side of FIG. 5A a four CPU computing platform running two virtual machines in production. Of the four machine CPUs, two are allocated to VM(P) (right), and two are allocated to VM(other) (left). The machine's 5 GB of memory is also divided between these VMs, with a share of 3 GB for VM(P) and 2 GB to VM(other).

On the right hand side of FIG. 5A, there is shown a first step of applying changes to VM(P) according to some embodiments of the present invention, namely a new virtual machine, VM(T) (middle) is cloned and it will be used to apply the changes and test them. Since there are no free resources on the machine, resources of one of the VMs (e.g. VM(P) may be reduced (e.g. the resource share of VM(P) may be reduced to 1.5 CPUs and 2.5 GB of memory). Minimal resources may be allocated to VM(T) (e.g. 0.5 CPUs, 0.5 GB memory). The production image, P, is cloned from VM(P) to VM(T). The cloned image, T, is almost identical to P; but, it is personalized with a testing identity to distinguish it from production. At this point, the change-over may be applied on VM(T) and one or more test may be run. Since there is only minimal disruption to production (VM(P) has slightly less resources), thorough testing of VM(T) may be performed.

The left hand side of FIG. 5B shows the state of the system upon completion of a testing phase. Production is still being served from VM(P), while the new, post change, server VM(T_{new}) is ready and tested. Now the change-over may be reflected in production by moving the production traffic from VM(P) to VM(T_{new}). As illustrated on the right hand side of FIG. 5B, VM(P_{old}) may be taken off production and its resources may be transferred to VM(T_{new}). VM(T_{new}) may assume a production related identity; namely, its image is personalized to become VM(P_{new}). Production traffic may then directed to VM(P_{new}) and production resumed. VM(P_{old}) may be kept/stored with minimal resources, to allow it to quickly resume production in case a roll-back is need.

What is claimed:

1. A method of performing a change-over to a computer system comprising:
replacing a prior production computing component with a current production computing component running on the same computing platform as the prior production computing component, wherein the current production computing component is produced by applying a change-over procedure to a clone of the prior production component.

2. The method according to claim 1, further comprising testing the current production component after undergoing the change-over but before replacing the prior production component.

3. The method according to claim 2, comprising replacing the prior production component with a current production component only if the current production component passed testing.

4. The method according to claim 3, wherein parameters associated with passing testing may be selected from the group consisting of stability, performance, and non-interference with other components.

5. The method according to claim 3, further comprising maintaining in a standby state the prior production component.

6. The method according to claim 5, further comprising reinstating the prior production component if the current production component appears to malfunction after being brought into production.

7. The method according to claim 1, wherein the prior production component is associated with a first virtual machine within a virtualization environment.

8. The method according to claim 7, wherein cloning the prior production component results in a clone which is a second virtual machine running on the same computing platform and sharing resources with the first virtual machine.

9. The method according to claim 8, further comprising applying the change-over to the second virtual machine and connecting the second virtual machine to a testing environment.

10. The method according to claim 9, further comprising connecting the second virtual machine to a production environment if it performs within predefined parameters while connected to the testing environment.

11. A computer system comprising:
a computing platform to run one or more computing components; and
a current production computing component produced by applying a change-over procedure to a clone of a prior production component and replacing the prior production computing component with the clone.

12. The system according to claim 11, wherein said current production computing component is produced by further testing the clone after the change-over but before replacing the prior production component.

13. The system according to claim 12, wherein said current production computing component is produced by replacing the prior production component with the clone only if the clone passed testing.

14. The system according to claim 13, wherein parameters associated with passing testing may be selected from the group consisting of stability, performance, and non-interference with other components.

15. The system according to claim 13, wherein said prior production component is maintained in a standby state.

16. The system according to claim 15, wherein said prior production component is reinstated if the current production component appears to malfunction after being brought into production.

17. The system according to claim 11, wherein said computing platform is running a virtualization environment and the prior production component is associated with a first virtual machine within the virtualization environment.

18. The system according to claim 17, wherein cloning the prior production component results in a clone which is a second virtual machine running on the same computing platform and sharing resources with the first virtual machine.

19. The system according to claim 18, further comprising applying the change-over to the second virtual machine and connecting the second virtual machine to a testing environment.

20. The system according to claim 19, further comprising connecting the second virtual machine to a production environment if it performs within predefined parameters while connected to the testing environment.
